(19) United States
(12) Patent Application Publication
(10) Pub. No.: US 2006/0090436 A1
(43) Pub. Date: May 4, 2006

(54) Filter media saturating resole resin

(75) Inventors: Frederick C. Dupre JR., Atlanta, GA (US); Kathryn M. Strong, Doraville, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 10/976,322

(22) Filed: Oct. 29, 2004

(51) Int. Cl. B01D 46/00

(52) U.S. Cl. 55/524

(57) ABSTRACT

An improved resole resin for producing filter media, e.g., paper, especially useful for automotive applications comprising a bisphenol-modified phenol-formaldehyde resin prepared using an amine catalyst.

### FIELD OF THE INVENTION

The present invention relates to a phenolic resole resin composition useful for saturating applications. The invention specifically relates to a resole resin made by reacting formaldehyde with a bis-phenol and phenol and catalyzed by an amine, especially triethylamine. Paper impregnated with the cured resin has particular utility in automotive filter applications.

### BACKGROUND OF THE INVENTION

The standard approach for making filtration media for automotive type filters (hot oil filters, fuel filters, air filters and vacuum filters) has been to saturate the filter medium (e.g., paper) with a phenolic resole type resin that is then B-staged. The B-staged phenolic resin improves the paper's strength properties and allows it to be pleated in an accordion-like shape and to hold this shape once the resin is fully cured on further heating. The standard phenolic resole resins used to treat automotive filter paper have had relatively low formaldehyde to phenol mol ratios, i.e., 0.8:1 to 1.5:1 formaldehyde:phenol (F:P) mol ratios. These low mol ratios are necessary to obtain good paper properties, especially flexibility for pleating the paper before curing the resin. Higher F:P mol ratio resins have tended to result in a more brittle paper when they are cured.

Conventional phenolic resole resins used in such applications are water insoluble, high molecular weight resins. Such resins are synthesized in an aqueous reaction medium using base catalysis, distilled to a high solids content and then dissolved in an alcohol solvent such as methanol, ethanol or isopropanol. The resin is usually neutralized after its synthesis to a pH of about 6.5 to 7.5, using an acid to give the resin a lighter color.

The standard method of making an automotive filter involves treating a base filter medium (e.g., paper) with an alcohol solution of the phenolic resole resin to saturate the paper with resin. Resin is usually applied to paper in dip roller pans. Treated paper then is passed through an oven to evaporate the solvent and make a B-staged resin-impregnated paper. This resin-impregnated paper then can be stored and/or shipped to a filter manufacturer for final assembly. Thereafter, resin-impregnated paper is cut and pleated and put through an oven to cure the resin and cause the paper to hold the shape of the pleats.

Conventional phenolic resole resins, such as those prepared by reacting bisphenol-A and phenol with formaldehyde using a sodium hydroxide (caustic) catalyst, have suitable oil-resistant, temperature stability and durability, water-resistant and chemical resistant properties making them particularly suitable for such automotive filter applications.

U.S. Pat. No. 4,045,398 to Dahms describes a resole resin suitable for use as a varnish that purportedly does not require organic solvents. Use of the resin in making oil filters is mentioned. A low molecular weight resole is prepared by reacting phenol or a substituted phenol with formaldehyde under basic conditions. Examples using phenol and a styrenated phenol are described and a variety of possible catalysts are identified for making resins, including triethylamine. The product is reported to have good flexibility and a low tendency to crack during use. The patent is especially directed to use of a boron compound curing accelerator in the formulation, which purportedly increases processing speed and improves final product properties.

U.S. Pat. No. 4,056,431 to Miller et al., describes using a phenol-formaldehyde-type resin made using bisphenol A and optionally a para-substituted phenol, for making a cellulosic overlay for wood composites. Sodium hydroxide is identified as the preferred catalyst for making the resin, though amines such as triethylamine are mentioned.

The art continues to search for resole resins, useful for saturating substrate media, such as paper, used in automotive filter applications, which provide the same level of performance in the final product but have other property improvements which allow for more rapid production techniques than conventional resins.

### DETAILED DESCRIPTION OF THE INVENTION

The present invention is directed to the use of a specific resole resin as a saturating resin especially for automobile filter (such as oil and fuel) applications. In a preferred embodiment, the resole resin is used in combination with, i.e., it is blended with, a novolac resin to obtain superior results in the filter application.

The resole resin of the present invention is made from phenol and formaldehyde in the presence of a modifying amount of a bisphenol, preferably bisphenol-A, and using an amine catalyst, especially a triethylamine catalyst. The resole resin is especially useful when combined with a novolac resin for impregnating filter media, e.g., paper. The neat resole resin and the combination of the resole resin with a novolac resin show improved mullen strengths (both wet and dry) and greater flexibilities as compared to currently commercially available resole resins for such applications, including a bisphenol A-modified resole resin made using a sodium hydroxide catalyst.

The present invention has particular utility in automotive filter applications generally encompassing air, fuel, oil and vacuum filter media such as filter paper and other nonwovens, impregnated with the fully cured bisphenol-modified phenolic resole resin. The resulting impregnated filter media have the necessary balance of permeability and other physical property requirements for such applications.

The phenolic resole resin of the present invention is dissolved in a suitable organic solvent, generally a water miscible solvent such as an alcohol (e.g. methanol, ethanol, isopropanol) or acetone, and then may be applied to the filter medium, typically a web or mat of fibers (e.g., cellulosic fiber web or paper) in any suitable fashion such as by spraying, dipping, roll-transferring, or the like. Application of the resole resin composition to the fiber mat is generally made at room temperature to avoid unnecessarily advancing the resin and complicating the cleaning of the associated saturating apparatus. The solids concentration of the resole resin solution suitable for applying to the web or mat of fibers is generally in the range of about 1 to 40 weight percent. For example, the solids concentration of the resole resin, as initially prepared, typically can be in the range of 45 to 70 weight percent, usually 60 to 70 weight percent. High solids contents are desirable to facilitate resin handling and minimize shipping and storage costs. The concentrated resin then is usually diluted to within the range of from 1 to 40 weight percent, more usually from 10 to 35 weight percent, when the resin is to be applied by dipping. When applied by roll-transfer, the solids concentration of the resin solution is generally diluted to about 25 weight percent whereas when using a spraying technique for saturating the substrate, it can range much more widely.

The amount of resole resin solids, i.e., calculated on a dry basis, applied to the filter media, such as paper, is that amount sufficient to bind the substrate together to form a self-sustaining web (if the web is not otherwise self-sustaining), permit pleating of the media as necessary and otherwise provide the impregnated media with desired oil-resistant, temperature stability and durability, water-resistant, chemical resistant and other properties. Typically, the solids loading ranges from about 3 to 65 weight percent of the filter media substrate, more usually from 15 to 35 weight percent.

Preferably a paper-based filter media or other nonwoven substrate, such as a polyester non-woven, is saturated with the resole resin composition and the treated media (e.g., paper) stock is dried (organic solvent is evaporated) by passing it through an air oven or equivalent heater. For example, the treated media may be dried for 8 minutes at 200° F. (93° C.) to B-stage the resin. However, other time-temperature relationships can be employed as is well known in the art to obtain a B-staged resin. Thereafter, the dried stock can subsequently be cured, for instance at 250-450° F. (121-232° C.) for a time of about 0.1 to 15 minutes or more.

The resole resin used in accordance with the present invention is similar to one that has been previously used for making filter papers. The resin is prepared by reacting an aldehyde, preferably formaldehyde, with a mixture of phenol and a bisphenol, especially bisphenol-A. While the prior art resin is prepared using caustic (sodium hydroxide) as a catalyst, the present invention requires (i.e., substitutes) the use of an amine catalyst. Suitable amines for use as the catalyst include primary amines (such as ethylamine, isobutylamine, ethanolamine, cyclohexylamine, and the like); secondary amines (such as diethanolamine, piperidine, morpholine, and the like); and tertiary amines (such as triethylamine, triethanolamine, diethyl cyclohexyl amine, triisobutyl amine; and the like). Triethylamine is the current catalyst of choice.

The amine catalyst is provided in an amount of at least about 0.1 part up to about 20 parts per 100 parts phenol used to make the resin. Usually, an amount of amine catalyst in the range of 3 to 10 parts amine per 100 parts of phenol should be satisfactory. The full complement of the amine can be introduced into the reaction mixture contemporaneous with any initial mixing of phenol and formaldehyde. It also is contemplated to add the amine in stages throughout the reaction between the phenol and formaldehyde. The presence of the amine also helps to maintain a suitable viscosity in the resole resin during distillation to increase the solids concentration of the resin.

In accordance with the present invention, the resole resin is prepared by reacting phenol (hydroxybenzene) (P) and formaldehyde (F) at a mole ratio (F:P) broadly within the range of about 1:1 to 2.2:1, preferably in the range of 1:1 to 2.0:1 and most often in the range of 1.2:1 to 1.7:1. In addition to phenol, an amount of a bisphenol, and preferably bisphenol-A also is added for co-reaction with the formaldehyde. An amount of bisphenol is added to provide from about 0.1 part by weight to about 20 parts by weight of bisphenol for each 100 parts of phenol for reaction with the formaldehyde. Preferably, the amount of bisphenol modifier is in the range of 1 to 18 parts by weight per 100 parts by weight of phenol and more usually is in the range of 5 to 15 parts per 100 parts phenol. In addition to the preferred use of bisphenol-A, bisphenol-F, methylolated bisphenol A and methylolated bisphenol-F can be used and are included within the meaning of bisphenol. As understood by those skilled in the art, the addition of the bisphenol modifier effectively reduces the F:P mole ratio as each mole of added bisphenol is essentially equivalent to two added moles of phenol.

The phenolic resole resin is prepared by reacting, in an aqueous reaction medium and under alkaline conditions established using the essential amine catalyst, the formaldehyde and phenol such that reactive methylol groups are formed in the resin product.

Formalin solutions are a suitable source for formaldehyde, though the formaldehyde also can be supplied as paraformaldehyde. Within the broad practice of the invention, some of the formaldehyde (up to about 20% and preferably no more than about 10%) can be replaced with another aldehyde such as acetaldehyde, propionaldehyde, butylaldehyde furfuraldehyde, and benzaldehyde. For most applications it is sufficient to use solely formaldehyde.

While phenol (hydroxybenzene) is the main phenolic component used to prepare the phenolic resole resin, a portion of it also may be replaced using any phenol-type material typically used in preparing phenolic resole resins, which is not substituted at either the two ortho positions or at one ortho and the para position, such unsubstituted positions being necessary for the desired polymerization (dimerization, trimerization, etc.) reactions to occur. While a minor portion of phenols substituted in these positions may be used in lesser quantities (e.g., up to about 10 weight %, and generally not more than about 5 weight %, of the phenol) as it is known in the art to control molecular weight by a chain termination reaction. Any one, all, or none of the remaining carbon atoms of the phenol ring can be substituted in a conventional fashion. The nature of these substituents can vary widely, and it is only necessary that the substituent not interfere in the polymerization of the formaldehyde with the phenol at the ortho and/or para positions thereof.

Substituted phenols that can be used to replace a small portion of the phenol (hydroxybenzene), generally no more than about 15%, include, for example, alkyl substituted phenols, aryl substituted phenols, aralkyl substituted phenols, cycloalkyl substituted phenols, alkenyl-substituted phenols, alkoxy substituted phenols, aryloxy substituted phenols, and halogen-substituted phenols, the foregoing substituents possibly containing from 1 to 26, and usually from 1 to 9, carbon atoms. Specific examples of such substituted phenols include: o-cresol, m-cresol, p-cresol, 3,5-xylenol, 3,4-xylenol, 3,4,5-trimethylphenol, 3-ethyl phenol, 3,5-diethyl phenol, p-butyl phenol, 3,5-dibutyl phenol, p-amyl phenol, p-cyclohexyl phenol, p-octyl phenol, 3,5-dicyclohexyl phenol, p-phenyl phenol, p-crotyl phenol, phenylethyl, 3,5-dimethoxy phenol, 3,4,5-trimethoxy phenol, p-ethoxy phenol,p-butoxy phenol, 3-methyl-4-methoxy phenol, p-phenoxy phenol and mixtures thereof. A small amount of di-functional phenol such as resorcinol, catechol, or hydroquinone or p,p′-dihydroxy bi-phenyl also may replace some of the phenol.

The resole resin is prepared using any of the known techniques for reacting phenol and formaldehyde. For example, the full complement of phenol and formaldehyde, along with the bisphenol, can be mixed together, heated to a temperature suitable for promoting the reaction, e.g., about 45-65° C., and then the amine catalyst can be added to foster the reaction. The ensuing exothermic reaction then is generally controlled, such as by cooling the reaction medium to a temperature in the range of 70-90° C., to produce a suitable resole resin product. Alternatively, to the full complement of the phenol and bisphenol reactants, heated to an appropriate initiation temperature, an amine catalyst is added and then the formaldehyde is added in stages (programmed addition). These and other ways for conducting the reaction between the formaldehyde and the phenol and bisphenol reactants are well-known to those skilled in the art and can be used to prepare the resole resin of the present invention, Such techniques do not require detailed description.

Following preparation of the resole resin, most of the water is distilled from the resole resin product, preferably using a vacuum assist so as not to unnecessarily advance the resole resin. Generally, the resulting resin has a solids content above about 50 weight percent and most often between 60 and 70 weight percent to facilitate its transport and storage. Thereafter, an organic solvent is added to ready the resin for impregnating (saturating) the filter media (e.g., paper). Suitable organic solvents include alcohols, such as methanol, ethanol and isopropanol, ethyl acetate, diacetone alcohol, acetone, methylethylketone and the like. Generally following dehydration, and before dilution, an acid also is added to neutralize the resin. Lactic acid is a preferred neutralization acid, though oxalic acid or another reducing acid can be substituted. As is well known, such acids help to minimize adverse color development in the cured resole resin. If color is not a concern, then other acids, including mineral acids, could be used to adjust the pH. Often a chelating agent, such as Dissolvine D40, or EDTA, also is added to bind any soluble iron, thus further preventing the resin from curing to a dark color.

The resole resin can be used alone for treating (saturating) the filter media, or in some instances can be blended with other ingredients before it is used. In one preferred embodiment, exemplified in the following examples, the resole resin can be blended with a novolac resin before use. As understood by those skilled in the art, novolac resins are acid-catalyzed phenol-formaldehyde resins generally made at an F:P mol of less than about 1:1, e.g., at an F:P mol ratio in the range of 0.7:1 to 0.95:1. Such resins are not themselves thermosetting. The nature of the novolac resin for blending with the resole resin of this invention is not critical. Generally, the resole resin-novolac resin blend will contain these components in a weight ratio (resole:novolac) in the range of about 10:90 to 90:10 and more usually in the range of 50:50 to 80:20. Suitable novolac resins are commercially available, such as from G-P Resins, Inc.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention, which is limited only by the appended claims

### EXAMPLE 1

Phenol (37.2 parts by weight (pbw)) and bisphenol-A (4.92 pbw) are added to a reactor, mixed and heated to about 55° C. Thereafter, a first portion of 50% formaldehyde (7.36 pbw) is added and then a triethylamine catalyst (2.36 pbw) is added over 15 minutes. The remaining 50% formaldehyde (29.4 pbw) is added over a 45 minute period. Over the next 35 minutes, the reaction mixture is allowed to exotherm to about 90° C. and is held at that temperature until the resin is advanced to a Stroke Cure rate of about 60-70 seconds. Generally, the reaction period to this point will have been about 2.5 hours. Samples for assessing the Stroke Cure should be taken every 30 minutes until 1.5 hours of reaction time and thereafter every 15 minutes. The resin then is vacuum distilled while it was cooled to a temperature of 50-55° C. When the water content had been reduced to about 10% by weight, methanol (in an amount of 2.82 pbw) is added and the resin is mixed for about 10 minutes. Then, the resin is held until the desired extent of reaction (viscosity) has been attained. The extent of reaction (viscosity) is monitored as follows. A sample of resin is taken from the reactor (an 83 gram sample of resin) and mixed with 17 grams of methanol, the mixture is cooled to 25° C. and then its refractive index (RI) is measured. If the RI of the sample is lower than the range of 1.5260-1.5290, additional resin is added to the sample until the target RI range is achieved and conversely if the RI of the sample is higher than the target range then additional methanol is added to the sample until the target RI range is achieved. The viscosity of the sample is then measured to determine its Gardner-Holdt viscosity. If the G-H viscosity is lower than the range of OOP-SST, then the resin is heated to 74-76° C. temperature for an additional 15 minutes and another sample of resin is taken from the reactor (an 83 gram sample of resin) and mixed with 17 grams of methanol, the mixture is cooled to 25° C. and then the same procedure above for the first sample is repeated. This procedure of heating and sampling is repeated until the target RI and target viscosity ranges are achieved on the sample.

Once the desired RI (viscosity) is obtained, an additional 12.1 pbw of methanol is added to the resin, followed by 0.099 pbw of a chelating agent (Dissolvine D40). Additional methanol, up to 2 pbw, is finally added to adjust the resin RI to 1.524 to 1.530.

Finally, up to 1.54 pbw of lactic acid is added in small increments to adjust the pH to between 6.4 and 6.9, with 10 minutes of mixing between additions.

### EXAMPLE 2

A resole resin of the type produced in Example 1 was compared with commercially available resole resins for performance as a substrate for filter applications. In particular, the resole resin of the type produced in Example 1 was compared with commercial resole resins 932D70 and 308G34 (an unmodified phenolic resin), both currently being used in the filter industry. Resin 932D70, in particular, is a sodium hydroxide catalyzed-phenol/bisphenol resole resin.

In particular, paper was treated (saturated) with equal amounts of the resin of the type produced in Example 1, with Resin 932D70, and with blends of these resins with a commercial novolac resin (Novolac resin 149D90) (in amounts to produce a 70:30 resole:novolac blend) to provide test samples. A blend of the novolac and Resin 308G34 also was prepared and used to saturate the paper for comparison. The various resin-saturated samples were cured at both 300° F. and at 350° F. for 5, 7 and 10 minutes and then the samples were tested for dry mullen. Mullen values (bursting strength of paper) of paper samples are measured using the MULLEN® Tester manufactured by B.F. Perkins in accordance with ASTM D774-97. Twenty replicates were performed for every saturating resin composition at each cure condition. The average values are reported in the following tables, with the Standard Deviation shown in parenthesis.

| Cure Temperature | Cure Time | Dry Mullen | Dry Mullen |
|---|---|---|---|
| (° F.) | (minutes) | Resole of Example 1 | Resole 932D70 |
| 300 | 5 | 59.5 (6.6) | 55.4 (5.5) |
| | 7 | 59.2 (7.2) | 57.7 (6.2) |
| | 10 | 60.3 (5.1) | 55.9 (5.4) |
| 350 | 5 | 50.2 (7) | 48.8 (5.0) |
| | 7 | 50.5 (6.8) | 44.8 (5.8) |
| | 10 | 48 (3.8) | 44.6 (4.5) |

| Cure | | Dry Mullen | Dry Mullen | Dry Mullen |
|---|---|---|---|---|
| Tem- | Cure | Novolac Blend | Novolac Blend | Novolac Blend |
| perature | Time | with Resole of | with Resole | with Resole |
| (° F.) | (minutes) | Example 1 | 932D70 | 308G34 |
| 300 | 5 | 48.8 (4.8) | 41 (5.2) | 44.2 (4.4) |
| | 7 | 57.7 (6.3) | 53.7 (6.2) | 54.7 (6.4) |
| | 10 | 63.6 (7.7) | 60.7 (5.4) | 58.5 (5.9) |
| 350 | 5 | 54.3 (6.4) | 56.1 (7.1) | 57.8 (5.2) |
| | 7 | 53.3 (5.0) | 54.6 (5.5) | 56.7 (5.7) |
| | 10 | 53.4 (4.9) | 52.1 (5.2) | 53.4 (4.5) |

### EXAMPLE 3

A resole resin of the type prepared in Example 1 was compared with commercially available resole resins for performance. In particular, the resole resin of the type prepared in Example 1 was compared with commercial resole resins 624D30, and 308G34, both currently being used in the filter industry.

In particular, a commercially available filter paper was treated in a dip saturation process with resin pickup in the range of 17-23% (resin solids) by weight of the paper. Subsequent “B” staging of the resin-saturated paper was conducted, to simulate a higher temperature curing, by heating in an oven (180° C.) for the noted time in seconds. This latter condition more closely represents actual curing conditions, as there is some heating in driving off the solvent and volatiles resulting in slight increase in resin molecular weight. Treated hand sheets then were cured and equilibrated in a constant temperature and humidity room at 72° F., 50% relative humidity; all prior to Mullen testing. For wet mullen testing, the treated paper was soaked for 1 minute in distilled water containing 0.1% by weight surfactant and then tested wet. Paper was treated with the resin of the type prepared in Example 1, Resin 624D30, Resin 308G34 and blends of these resins with a commercial novolac resin (Novolac resin 149D90) (the blends were made at 70:30 resole:novolac weight ratio) to provide test samples. The various samples were cured at 356° F. (180° C.) for 42, 72, 102 and 180 seconds and then were tested both for dry and wet mullens. Mullen values (bursting strength of paper) of paper samples are measured using the MULLEN® Tester manufactured by B.F. Perkins in accordance with ASTM D774-97. Fifteen replicates were performed for every composition at each cure condition. The average values (psi) are reported in the following tables.

| Cure Time | Dry Mullen | Dry Mullen | Dry Mullen |
|---|---|---|---|
| (Seconds) | Resole of Example 1 | Resole 624D30 | Resole 308G34 |
| 40 | 48.7 (2.7) | 46.2 (2.8) | 43.6 (3.2) |
| 72 | 50.4 (3.3) | 45.8 (2.9) | 41.6 (2.3) |
| 102 | 46.7 (3.8) | 40.1 (3.7) | 43.3 (2.7) |
| 180 | 47.4 (3.9) | 42 (4.9) | 42.1 (3.3) |

| Cure Time | Wet Mullen | Wet Mullen | Wet Mullen |
|---|---|---|---|
| (Seconds) | Resole of Example 1 | Resole 624D30 | Resole 308G34 |
| 40 | 28.7 (2.3) | 29.3 (2.5) | 29.1 (1.8) |
| 72 | 37.1 (2.7) | 38.5 (2.7) | 37.2 (2.5) |
| 102 | 38.7 (3.4) | 38.7 (3.0) | 37.5 (3.1) |
| 180 | 39.8 (2.1) | 37.2 (2.5) | 36.1 (3.1) |

| | Dry Mullen | Dry Mullen | |
|---|---|---|---|
| | Novolac Blend | Novolac Blend | Dry Mullen |
| Cure Time | with Resole | with Resole | Novolac Blend with |
| (Seconds) | of Example 1 | 624D30 | Resole 308G34 |
| 40 | 42.9 (3.2) | 40.9 (3.2) | 41.6 (3.4) |
| 72 | 48.7 (4.0) | 45.6 (3.7) | 48.2 (4.9) |
| 102 | 49.7 (4.0) | 44.2 (4.5) | 46.8 (3.0) |
| 180 | 49 (2.6) | 43.8 (2.8) | 46.1 (4.0) |

| | Wet Mullen | Wet Mullen | |
|---|---|---|---|
| | Novolac Blend | Novolac Blend | Wet Mullen |
| Cure Time | with Resole | with Resole | Novolac Blend with |
| (Seconds) | of Example 1 | 624D30 | Resole 308G34 |
| 40 | 20.2 (3.1) | 25.5 (3.6) | 24.7 (2.2) |
| 72 | 32.4 (3.1) | 36.5 (2.6) | 35 (1.7) |
| 102 | 38.2 (2.3) | 37.5 (2.2) | 39 (2.5) |
| 180 | 41.3 (3.5) | 39.5 (2.9) | 38.8 (3.0) |

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5% and preferably is only about + or −2%.

We claim:

1. A resole resin composition comprising the reaction product of formaldehyde (F), phenol (P) and a bisphenol in an F:P mol ratio in the range of 1:1 to 2.2:1, said formaldehyde, phenol and bisphenol being reacted in the presence of an amine catalyst.

2. A filter medium impregnated with a B-staged resole resin composition wherein the resole resin composition comprises the reaction product of formaldehyde (F), phenol (P) and a bisphenol in an F:P mol ratio in the range of 1:1 to 2.2:1, said formaldehyde, phenol and bisphenol being reacted in the presence of an amine catalyst.

3. A filter comprising a filter medium impregnated with a cured resole resin composition wherein the resole resin composition comprises the reaction product of formaldehyde (F), phenol (P) and a bisphenol in an F:P mol ratio in the range of 1:1 to 2.2:1, said formaldehyde, phenol and bisphenol being reacted in the presence of an amine catalyst.

4. In a process for producing a resole resin-impregnated filter medium in which a filter medium is saturated with a resole resin prepared from phenol, a bisphenol and formaldehyde, the resole resin is B-staged, and then the B-staged resin is cured, the improvement comprising using a resole resin prepared in the presence of an amine catalyst.

5. A composition for impregnating a filter medium comprising a mixture in an organic solvent of (A) a resole resin comprising the reaction product of formaldehyde (F), phenol (P) and a bisphenol in an F:P mol ratio in the range of 1:1 to 2.2:1, said formaldehyde, phenol and bisphenol being reacted in the presence of an amine catalyst and (B) a novolac resin.

6. A filter medium impregnated with the composition of claim 5 wherein the resole resin has been B-staged.

7. A filter comprising a filter medium impregnated with the composition of claim 5 wherein the resole resin has been cured.

8. The invention of claim 1, 2, 3 or 4 wherein the bisphenol is bisphenol-A.

9. The invention of claim 8 wherein the amine catalyst is triethylamine.

10. The invention of claim 5, 6 or 7 wherein the bisphenol is bisphenol-A.

11. The invention of claim 10 wherein the catalyst is triethylamine.

12. The invention of claim 11 wherein the resole resin (A) and the novolac resin (B) are used in a solids weight ratio (A:B) in the range of 50:50 to 80:20.

13. The invention of claim 9 wherein the bisphenol is included in an amount of 1 to 18 parts by weight per 100 parts by weight of phenol.

14. The invention of claim 12 wherein the bisphenol is included in an amount of 1 to 18 parts by weight per 100 parts by weight of phenol.
